(19) United States
(12) Patent Application Publication
(10) Pub. No.: US 2026/0339863 A1
(43) Pub. Date: Oct. 29, 2026

(54) DATA TRANSMISSION DEVICE AND METHOD FOR CIRCULAR BUFFER

(71) Applicant: Nuvoton Technology Corporation, Hsinchu Science Park (TW)

(72) Inventor: Chung-Hsiang HSIEH, Kaohsiung City (TW)

(21) Appl. No.: 19/362,912

(22) Filed: Oct. 20, 2025

(30) Foreign Application Priority Data
Apr. 29, 2025 (TW) 114116088

(51) Int. Cl. G06F 13/28

(52) U.S. Cl. CPC G06F 13/28; G06F 2213/28

(57) ABSTRACT

An embodiment of the invention provides a data transmission device for circular buffer. The data transmission device for circular buffer may include a circular buffer and a controller. The controller may be coupled to the circular buffer. The controller may have an input direct memory access (DMA) channel and a plurality of output DMA channels. The controller may control read operations and write operations of the circular buffer through the input DMA channel and the plurality of output DMA channels according to a circular buffer descriptor table list.

### CROSS REFERENCE TO RELATED APPLICATIONS

This Application claims priority of TW Patent Application No. 114116088 filed on Apr. 29, 2025, the entirety of which is incorporated by reference herein.

### BACKGROUND OF THE INVENTION

### Field of the Invention

The invention generally relates to data authentication technology, and more particularly, to a direct memory access (DMA) technology for the DMA technology applied to circular buffer.

### Description of the Related Art

The peripheral direct memory access (PDMA) technology is widely used with the system on a chip (SOC) to reduce the loading of the central processing unit (CPU) for data transmission between a peripheral device and system memory. The PDMA may have multiple channels. Each channel may be used to transmit data independently without communicating with each other. That is, each channel may perform data transmission according to its corresponding descriptor table list.

The circular buffer may be a data structure of software. In a multi-tread environment, if the circular buffer is accessed by different treads, the circular buffer may perform atomic operation to achieve the tread-safe.

How to combine the operations of a PDMA having multi-channels with a circular buffer is a topic worthy of discussion.

### BRIEF SUMMARY OF THE INVENTION

A data transmission device and method for circular buffer are provided to overcome the problems mentioned above.

An embodiment of the invention provides a data transmission device for circular buffer. The data transmission device for circular buffer may comprise a circular buffer and a controller. The controller may be coupled to the circular buffer. The controller may have an input direct memory access (DMA) channel and a plurality of output DMA channels. The controller may control read operations and write operations of the circular buffer through the input DMA channel and the plurality of output DMA channels according to a circular buffer descriptor table list.

In an embodiment, each of descriptor tables in the circular buffer descriptor table list may comprise source address information, destination address information, next descriptor table information, and transmission type and data information.

In an embodiment, when the input DMA channel has completed a write operation corresponding to one of descriptor tables in the circular buffer descriptor table list, the input DMA channel may notify all output DMA channels which are in an idle mode that the write operation corresponding to the one of the descriptor table has been completed.

In an embodiment, when the input DMA channel has completed the write operation corresponding to the one of the descriptor tables, and there is no storage space that can be written to in the circular buffer, the input DMA channel may enter the idle mode.

In an embodiment, when one of the plurality of output DMA channels has completed a read operation corresponding to one of descriptor tables in the circular buffer descriptor table list, the one of the plurality of output DMA channels may notify the input DMA channel that the read operation corresponding to the one of the descriptor tables has been completed.

In an embodiment, when the one of the plurality of output DMA channels has completed the read operation corresponding to the one of the descriptor tables, and there is no data that needs to be read in the circular buffer, the one of the plurality of output DMA channels may enter an idle mode.

An embodiment of the invention provides a data transmission method for circular buffer. The data transmission method may be applied to a data transmission device. The data transmission method may comprise the following steps. The controller of the transmission device may select an input direct memory access (DMA) channel and a plurality of output DMA channels from a plurality of DMA channels. Then, the controller may control read operations and write operations of a circular buffer of the data transmission device through the input DMA channel and the plurality of output DMA channels according to a circular buffer descriptor table list.

Other aspects and features of the invention will become apparent to those with ordinary skill in the art upon review of the following descriptions of specific embodiments of a data transmission device and method for circular buffer.

### BRIEF DESCRIPTION OF THE DRAWINGS

The invention will become more fully understood by referring to the following detailed description with reference to the accompanying drawings, wherein:

FIG. 1 is a block diagram of a data transmission device 100 according to an embodiment of the invention;

FIG. 2 is a schematic diagram illustrating the operations of the DMA channel group for the circular buffer according to an embodiment of the invention;

FIG. 3 is a flow chart illustrating the operations of the DMA channel group for the circular buffer according to an embodiment of the invention; and

FIG. 4 is a flow chart illustrating a data transmission method for the circular buffer according to an embodiment of the invention.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

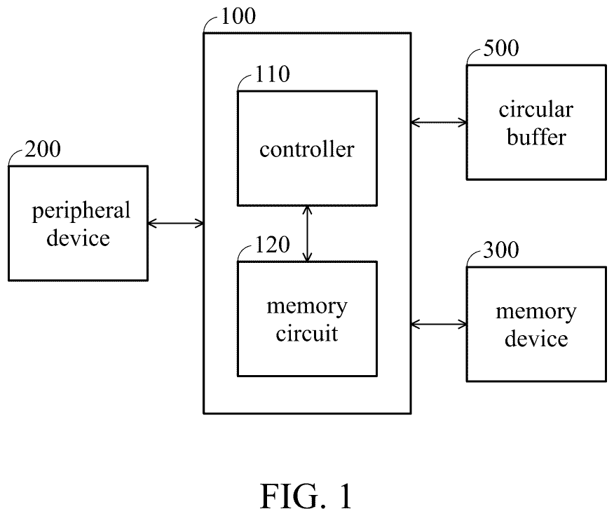

FIG. 1 is a block diagram of a data transmission device 100 according to an embodiment of the invention. As shown in FIG. 1, the data transmission device 100 may comprise a controller 110 and a memory circuit 120. It should be noted that FIG. 1 presents a simplified block diagram in which only the elements relevant to the invention are shown. However, the invention should not be limited to what is shown in FIG. 1. The data transmission device 100 may also comprise other elements.

According to an embodiment of the invention, the data transmission device 100 may be a direct memory access (DMA) controller or a peripheral direct memory access (PDMA) controller. In addition, the data transmission device 100 may be applied to the system on a chip (SOC) and the microcontroller (MCU), but the invention should not be limited thereto. In addition, as shown in FIG. 1, the data transmission device 100 may be configured between the peripheral device 200 (e.g., a universal asynchronous receiver/transmitter (UART), a serial peripheral interface bus (SPI), a graphic display card, a network card, a sound card, and so on) and the memory device 300 (e.g., a working buffer, a system memory, and so on) to control the read operations and write operations between the peripheral device 200 and the memory device 300. Specifically, the data transmission device may control the read operations and write operations between the peripheral device 200 and the memory device 300 through the circular buffer (or ring buffer) 500. According to an embodiment of the invention, the circular buffer 500 may be also configured in the peripheral 200 and/or the memory device 300.

According to an embodiment of the invention, the controller 110 may comprise a plurality of DMA channels to control the read operations and write operations of the circular buffer 500. Specifically, the controller 110 may select an input DMA channel and a plurality of output DMA channel from the DMA channels. The selected input DMA channel and output DMA channels may be used as a DMA channel group used for the read operations and write operations of the circular buffer 500. The input DMA channel may be used to perform the write operations (i.e., the data is written into the circular buffer 500) of the circular buffer 500. The output DMA channels may be used to perform the read operations (i.e., read data or move the data from the circular buffer 500) of the circular buffer 500. According to an embodiment of the invention, the DMA channel group may also only comprise an output DMA channel.

According to an embodiment of the invention, the controller 110 may control the read operations and write operations of the circular buffer 500 through the input DMA channel and the output DMA channels according to a circular buffer descriptor table list. The circular buffer descriptor table list may indicate a series of descriptor tables for the circular buffer. The input DMA channel may correspond to one descriptor table in the circular buffer descriptor table list. That is, the input DMA channel may perform the write operation (of the circular buffer 500) corresponding to a descriptor table at a time. One or more of the output DMA channels may correspond to one descriptor table in the circular buffer descriptor table list. That is, each output DMA channel may perform the read operation (of the circular buffer 500) corresponding to a descriptor table at a time, or multiple output DMA channels may perform the read operation (of the circular buffer 500) corresponding to a descriptor table at a time. According to the embodiments of the invention, the input DMA channel and the output DMA channels in the DMA channel group may share a descriptor table list. The shared descriptor table list may be regarded as a circular buffer descriptor table list.

In addition, according to an embodiment of the invention, each descriptor table may correspond to one or more storage spaces (storage addresses) of the circular buffer 500. That is, in an example, a descriptor table may correspond to the read operation or the write operation corresponding to a storage space of the circular buffer 500. In another example, a descriptor table may correspond to the read operations or the write operations corresponding to a group of continuous storage spaces of the circular buffer 500.

According to an embodiment of the invention, the circular buffer descriptor table list may be stored in the memory circuit 120. In addition, the memory circuit 120 may also store the data and software for the data transmission method for the circular buffer in the invention. According to another embodiment of the invention, the circular buffer descriptor table list may be stored in the memory device 300. The data transmission device 100 may obtain (or load) the circular buffer descriptor table list from the memory device 300.

According to an embodiment of the invention, each descriptor table in the circular buffer descriptor table list may comprise the source address information, the destination address information, the next descriptor table information, and the transmission type and data information, but the invention should not be limited thereto. The source address information may comprise the address of the circular buffer 500 where the data is read. The destination address information may comprise the address of the circular buffer 500 where the data is written. The next descriptor table information may indicate or point the next descriptor table corresponding to the following operations after the operation corresponding to the descriptor table has been completed. The transmission type may comprise the peripheral to memory (P2M) transmission, the memory to peripheral (M2P) operation, and the memory to memory (M2M) operation, but the invention should not be limited thereto. The data information may comprise the size of the data which needs to be read or written, but the invention should not be limited thereto.

According to an embodiment of the invention, when the input DMA channel has completed the write operation corresponding to a descriptor table in the circular buffer descriptor table list, the input DMA channel may notify (or trigger) all output DMA channels which are in the idle mode (e.g., the output DMA channel which has completed the read operation, or the output DMA channel which has not been assigned any operation) that the write operation corresponding to the descriptor table has been completed (i.e., the data has been written into the storage space corresponding to the descriptor table in the circular buffer 500). Then, one or more of the output DMA channels which are in the idle mode may perform the read operation corresponding to the descriptor table. In addition, when the input DMA channel has completed the write operation corresponding to a descriptor table in the circular buffer descriptor table list, the input DMA channel may perform the write operation of the next descriptor table which the descriptor table points to. When the input DMA channel has completed the write operation corresponding to a descriptor table in the circular buffer descriptor table list, and there is no any storage space cane be written to in the circular buffer 500 (e.g., the next descriptor table which the descriptor table points to is corresponded to a output DMA channel, or all write operations have been completed, but the invention should not be limited thereto), the input DMA channel may enter the idle mode.

According to an embodiment of the invention, when one of the output DMA channels has completed the read operation corresponding to one descriptor table in the circular buffer descriptor table list, the output DMA channel may notify (or trigger) the input DMA channel that the read operation corresponding to the descriptor table has been completed (i.e., the data has been read from the storage space corresponding to the descriptor table in the circular buffer 500). In addition, when one of the output DMA channels has completed the read operation corresponding to the descriptor table, and there is no data that needs to be read from the circular buffer 500 (e.g., the next predictor table which the predictor table points to is corresponded to an input DMA channel, or all read operations have been completed, but the invention should not be limited thereto).

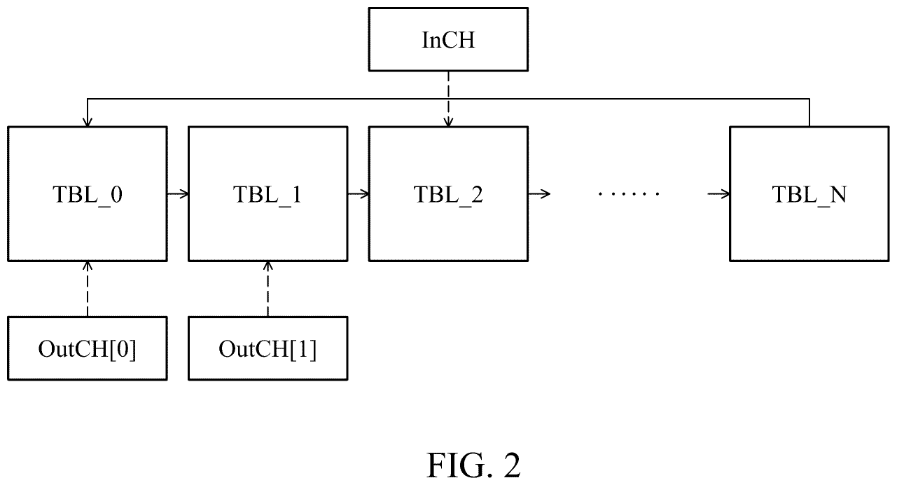

FIG. 2 is a schematic diagram illustrating the operations of the DMA channel group for the circular buffer according to an embodiment of the invention. As shown in FIG. 2, the DMA channel group may comprise an input DMA channel InCH, an output DMA channel OutCH[0], and an output DMA channel OutCH[1]. The controller 110 may control the read operations and write operations of the circular buffer 500 through the input DMA channel InCH, the output DMA channel OutCH[0], and the output DMA channel OutCH[1] according to the circular buffer descriptor table list TBL_0~TBL_N. The input DMA channel InCH may be configured to perform the write operations of the circular buffer 500. The output DMA channel OutCH[0], and the output DMA channel OutCH[1] may be configured to perform the read operations of the circular buffer 500.

For example, as shown in FIG. 2, the input DMA channel InCH is performing the write operation corresponding to the descriptor table TBL_2, and the output DMA channel OutCH[0] and the output DMA channel OutCH[1] are respectively performing the read operations corresponding to the descriptor table TBL_0 and the descriptor table TBL_1. When the input DMA channel InCH has completed the write operation corresponding to the descriptor table TBL_2, the input DMA channel InCH may notify the output DMA channel OutCH[1] which is in the idle mode (e.g., the output DMA channel OutCH[1] has completed the read operation corresponding to the descriptor table TBL_1) that the write operation corresponding to the descriptor table TBL_2 has been completed (i.e., the data has been written in the storage space corresponding to the descriptor table TBL_2 in the circular buffer 500). Therefore, the output DMA channel OutCH[1] in the idle mode may perform the read operation corresponding to the descriptor table TBL_2 (i.e., read data from the storage space corresponding to the descriptor table TBL_2 in the circular buffer 500). The input DMA channel InCH may continuously perform the write operation corresponding to the next descriptor table (e.g., the descriptor table TBL_3) which the descriptor table TBL_2 points to. When there is no storage space for write (e.g., the next descriptor table which the descriptor table points to has been corresponded to the output DMA channel OutCH[0] or the output DMA channel OutCH[1], or all write operations have been completed, but the invention should not be limited thereto), the input DMA channel InCH may enter the idle mode.

Specifically, the DMA channel group for circular buffer shown in FIG. 2 is only used to illustrate the embodiment of the invention, but the invention should not be limited thereto. The DMA channel group can also comprise different number of output DMA channels.

According to an embodiment of the invention, when the P2M transmission needs to be performed in the circular buffer 500, the peripheral device may trigger the data transmission device 100 to perform the write operation of the circular buffer 500 through the input DMA channel. Specifically, the data transmission device 100 may write the data from the peripheral device to the circular buffer 500 through the input DMA channel according to the circular buffer descriptor table list. In addition, according to the circular buffer descriptor table list, the data transmission device 100 may read the data corresponding to the write operation which has been completed (i.e., the data has been written into the circular buffer 500 through the input DMA channel) through the output DMA channels, and move the read data to the memory device (e.g., work buffer). In the embodiment, the operations of the output DMA channels may be triggered through the software, or triggered through the notification from the input DMA channel.

According to an embodiment of the invention, when the M2P transmission needs to be performed in the circular buffer 500, the data transmission device 100 may be triggered through the software or the notification of the output DMA channel to perform the write operation of the circular buffer 500 through the input DMA channel. Specifically, the data transmission device 100 may write the data from the memory device (e.g., working buffer) to the circular buffer 500 through the input DMA channel according to the circular buffer descriptor table list. In addition, according to the circular buffer descriptor table list, the data transmission device 100 may read the data corresponding to the write operation which has been completed (i.e., the data has been written into the circular buffer 500 through the input DMA channel) through the output DMA channels, and move the read data to the peripheral device. In the embodiment, the operations of the output DMA channels may be triggered by the peripheral device.

According to an embodiment of the invention, when the M2M transmission needs to be performed in the circular buffer 500, the data transmission device 100 may perform the write operation of the circular buffer 500 through the input DMA channel. Specifically, the data transmission device 100 may write the data from a storage space of the memory device (e.g., working buffer) to the circular buffer 500 through the input DMA channel according to the circular buffer descriptor table list. In addition, according to the circular buffer descriptor table list, the data transmission device 100 may read the data corresponding to the write operation which has been completed (i.e., the data has been written into the circular buffer 500 through the input DMA channel) through the output DMA channels, and move the read data to another storage space of the memory device (e.g., working buffer). In the embodiment, the operation of the input DMA channel may be trigger through the software, or triggered through the notification of the output DMA channels. In addition, in the embodiment, the operations of the output DMA channels may be triggered through the software, or triggered through the notification from the input DMA channel.

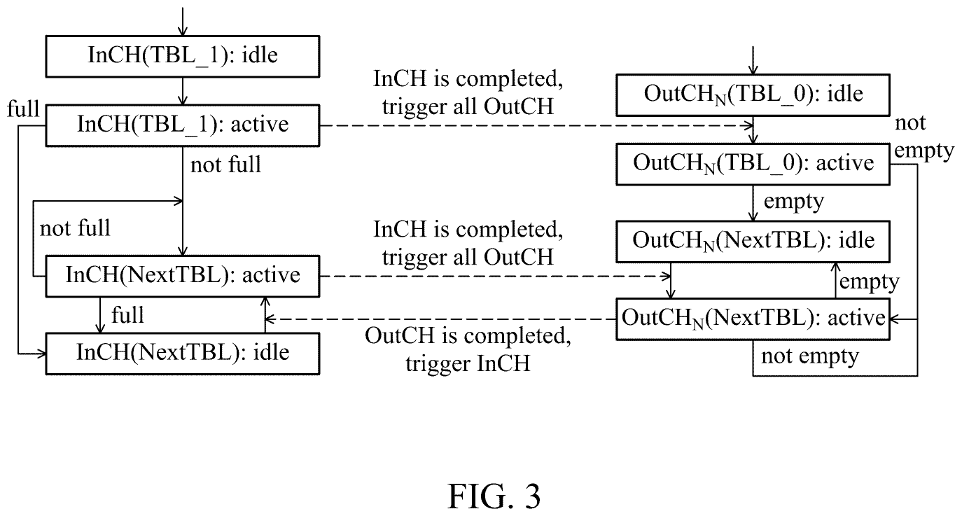

FIG. 3 is a flow chart illustrating the operations of the DMA channel group for the circular buffer according to an embodiment of the invention. The flow chart shown in FIG. 3 may be applied to the data transmission device 100. As shown in FIG. 3, it is assumed that the DMA channel group may comprise an input DMA channel InCH and N output DMA channels OutCH_{N}. The controller 110 may control the read operations and write operations of the circular buffer 500 through the input DMA channel InCH and the output DMA channels OutCH_{N} according to a circular buffer descriptor table list TBL_0~TBL_M. N and M may the same integer value or different integer values.

As shown in FIG. 3, in the operations of a circular buffer, in an initial state, the input DMA channel InCH may be activated from the idle mode, and perform the write operation corresponding to the descriptor table TBL_1. When the input DMA channel InCH has completed the write operation corresponding to the descriptor table TBL_1, the input DMA channel InCH may notify the output DMA channels OutCH_{N} which are in the idle mode that the write operation corresponding to the descriptor table TBL_1 has been completed. Then, the output DMA channels OutCH_{N} may be triggered to perform the read operation corresponding to the descriptor table TBL_1. If the circular buffer 500 still has storage space for write (i.e., not full), the input DMA channel may continuously perform the write operation corresponding to the next descriptor table NextTBL which the descriptor table TBL_1 points to. If the circular buffer 500 has not heaven the storage space for write (i.e., full), the input DMA channel may enter the idle mode. Accordingly, when the input DMA channel has completed the write operation corresponding to the next descriptor table NextTBL, the input DMA channel InCH may notify the output DMA channels OutCH_{N} which are in the idle mode that the write operation corresponding to the next descriptor table NextTBL has been completed, and then continuously perform the write operation corresponding to another next descriptor table NextTBL.

In addition, when the output DMA channels OutCH_{N} have completed the read operation corresponding to the descriptor table TBL_1, and there is no data that needs to be read (i.e., empty) in the circular buffer 500, the output DMA channels OutCH_{N} may enter the idle mode. If there is data which has not been read (i.e., not empty) in the circular buffer 500, the output DMA channels OutCH_{N} may continuously perform the read operation corresponding to the next descriptor table NextTBL which the descriptor table TBL_1 points to. In an embodiment, the reason of the input DMA channel InCH entering the idle mode may be that the pointed descriptor table still being used by an output DMA channel OutCH. Therefore, the input DMA channel InCH cannot perform the write operation. Therefore, in the embodiment, when the output DMA channel OutCH has completed the read operation, the output DMA channel OutCH may notify the input DMA channel InCH. Then, the input DMA channel InCH may check whether the circular buffer 500 is full. If the circular buffer 500 is not full, the input DMA channel InCH may perform the write operation.

It should be noted that, in FIG. 3, OutCH_{N} is used to express all output DMA channels, but the invention should not be limited thereto. Different output DMA channels may also be configured to the read operations corresponding to different descriptor tables.

The operations for the circular buffer performed through the DMA channel group (e.g., one input DMA channel and a plurality of output DMA channels) in the embodiments of the invention also can be applied to different data transmissions. For example, the input DMA channel may store the image input by the complementary metal-oxide-semiconductor (CMOS) sensor to the circular buffer for the later display review and image recognition. In addition, the input DMA channel may compress the image to the joint photographic experts group (JPEG) file first, and then store the compressed image to the circular buffer.

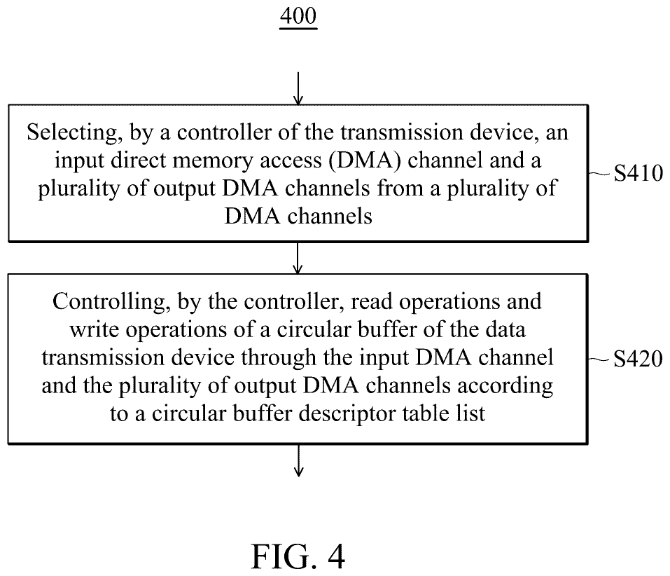

FIG. 4 is a flow chart illustrating a data transmission method for the circular buffer according to an embodiment of the invention. The data transmission method shown in FIG. 4 can be applied to the data transmission device 100. As shown in FIG. 4, in step S410, the controller of the data transmission device 100 may select an input DMA channel and a plurality of output channels from among a plurality of DMA channels.

In step S420, the controller of the data transmission device 100 may control the read operations and the write operations of a circular buffer of the data transmission device 100 through the input DMA channel and the output DMA channels according to a circular buffer descriptor table list.

According to an embodiment of the invention, in the data transmission method for the circular buffer, each of descriptor tables in the circular buffer descriptor table list may comprise source address information, destination address information, next descriptor table information, and transmission type and data information.

According to an embodiment of the invention, in the data transmission method for the circular buffer, each of the descriptor tables in the circular buffer descriptor table list may correspond to one or more storage spaces of the circular buffer.

According to an embodiment of the invention, in the data transmission method for the circular buffer, when the input DMA channel has completed the write operation corresponding to one of descriptor tables in the circular buffer descriptor table list, the input DMA channel may notify all output DMA channels which are in an idle mode that the write operation corresponding to the one of the descriptor tables has been completed.

According to an embodiment of the invention, in the data transmission method for the circular buffer, when the input DMA channel has completed the write operation corresponding to the one of the descriptor tables, and there is no storage space that can be written to in the circular buffer, the input DMA channel may enter an idle mode.

According to an embodiment of the invention, in the data transmission method for the circular buffer, when one of the plurality of output DMA channels has completed the read operation corresponding to one of descriptor tables in the circular buffer descriptor table list, the one of the plurality of output DMA channels may notify the input DMA channel that the read operation corresponding to the descriptor has been completed.

According to an embodiment of the invention, in the data transmission method for the circular buffer, when the one of the plurality of output DMA channels has completed the read operation corresponding to the one of the descriptor tables, and there is no data that needs to be read in the circular buffer, the one of the plurality of output DMA channels may enter an idle mode.

According to the data transmission method for the circular buffer provided in the invention, the DMA channel group can be applied to the write operations and read operations of the circular buffer (or ring buffer). In addition, the input DMA channel and the output DMA channels in the DMA channel group can share a circular buffer descriptor table list and can communicate each other to avoid the interaction of the threads. That is, the operations of the input DMA channel and the output DMA channels provided in the invention can achieve the effect of the atomic operation.

Use of ordinal terms such as “first”, “second”, “third”, etc., in the disclosure and claims is for description. It does not by itself connote any order or relationship.

The steps of the method described in connection with the aspects disclosed herein may be embodied directly in hardware, in a software module executed by a processor, or in a combination of the two. A software module (e.g., including executable instructions and related data) and other data may reside in a data memory such as RAM memory, flash memory, ROM memory, EPROM memory, EEPROM memory, registers, a hard disk, a removable disk, a CD-ROM, or any other form of computer-readable storage medium known in the art. A sample storage medium may be coupled to a machine such as, for example, a computer/processor (which may be referred to herein, for convenience, as a “processor”) such that the processor can read information (e.g., code) from and write information to the storage medium. A sample storage medium may be integral to the processor. The processor and the storage medium may reside in an ASIC. The ASIC may reside in user equipment. Alternatively, the processor and the storage medium may reside as discrete components in user equipment. Moreover, in some aspects any suitable computer-program product may comprise a computer-readable medium comprising codes relating to one or more of the aspects of the disclosure. In some aspects a computer program product may comprise packaging materials.

The above paragraphs describe many aspects. Obviously, the teaching of the invention can be accomplished by many methods, and any specific configurations or functions in the disclosed embodiments only present a representative condition. Those who are skilled in this technology will understand that all of the disclosed aspects in the invention can be applied independently or be incorporated.

While the invention has been described by way of example and in terms of preferred embodiment, it should be understood that the invention is not limited thereto. Those who are skilled in this technology can still make various alterations and modifications without departing from the scope and spirit of this invention. Therefore, the scope of the present invention shall be defined and protected by the following claims and their equivalents.

What is claimed is:

1. A data transmission device for circular buffer, comprising:
a circular buffer;
a controller, coupled to the circular buffer, and having an input direct memory access (DMA) channel and a plurality of output DMA channels,
wherein the controller controls read operations and write operations of the circular buffer through the input DMA channel and the plurality of output DMA channels according to a circular buffer descriptor table list.

2. The data transmission device for circular buffer of claim 1, wherein each of descriptor tables in the circular buffer descriptor table list comprises source address information, destination address information, next descriptor table information, and transmission type and data information.

3. The data transmission device for circular buffer of claim 1, wherein when the input DMA channel has completed a write operation corresponding to one of descriptor tables in the circular buffer descriptor table list, the input DMA channel notifies all output DMA channels which are in an idle mode that the write operation corresponding to the one of the descriptor tables has been completed.

4. The data transmission device for circular buffer of claim 3, wherein when the input DMA channel has completed the write operation corresponding to the one of the descriptor tables and there is no storage space that can be written to in the circular buffer, the input DMA channel enters the idle mode.

5. The data transmission device for circular buffer of claim 1, wherein when one of the plurality of output DMA channels has completed a read operation corresponding to one of the descriptor tables in the circular buffer descriptor table list, the one of the plurality of output DMA channels notifies the input DMA channel that the read operation corresponding to the one of the descriptor tables has been completed.

6. The data transmission device for circular buffer of claim 5, wherein when the one of the plurality of output DMA channels has completed the read operation corresponding to the one of the descriptor tables and there is no data that needs to be read in the circular buffer, the one of the plurality of output DMA channels enters an idle mode.

7. A data transmission method for circular buffer, applied to a data transmission device, and the data transmission method comprises:
selecting, by a controller of the transmission device, an input direct memory access (DMA) channel and a plurality of output DMA channels from a plurality of DMA channels; and
controlling, by the controller, read operations and write operations of a circular buffer of the data transmission device through the input DMA channel and the plurality of output DMA channels according to a circular buffer descriptor table list.

8. The data transmission method for circular buffer of claim 7, further comprising:
when the input DMA channel has completed a write operation corresponding to one of descriptor tables in the circular buffer descriptor table list, and there is no storage space that can be written to in the circular buffer, the input DMA channel enters an idle mode.

9. The data transmission method for circular buffer of claim 7, further comprising:
when one of the plurality of output DMA channels has completed a read operation corresponding to one of descriptor tables in the circular buffer descriptor table list, notifying, by the one of the plurality of output DMA channels, the input DMA channel that the read operation corresponding to the one of the descriptor tables has been completed.

10. The data transmission method for circular buffer of claim 9, further comprising:
when the one of the plurality of output DMA channels has completed the read operation corresponding to the one of the descriptor tables and there is no data that needs to be read in the circular buffer, the one of the plurality of output DMA channels enters an idle mode.
